(19) United States
(12) Patent Application Publication
(10) Pub. No.: US 2026/0145674 A1
(43) Pub. Date: May 28, 2026

(54) VEHICLE CONTROL APPARATUS AND PROGRAM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventor: Takumi ONOMICHI, Tokyo (JP)

(21) Appl. No.: 19/402,452

(22) Filed: Nov. 26, 2025

(30) Foreign Application Priority Data
Nov. 28, 2024 (JP) 2024-207588

(51) Int. Cl. B60W 30/12

(52) U.S. Cl. CPC B60W 30/12; B60W 2520/06; B60W 2520/10; B60W 2552/20; B60W 2552/53; B60W 2554/801

(57) ABSTRACT

A vehicle control apparatus performs deviation suppression control to prevent a vehicle from deviating outside left and right reference boundary lines when traveling on a road. The vehicle control apparatus sets a travel path ahead of the vehicle in a travelling direction, and recognizes presence of an obstacle ahead of the vehicle. When an object is recognized as being present ahead of the vehicle, the vehicle control apparatus determines whether the travel path is in an obstacle overlapping state intersecting the reference boundary line and overlapping the obstacle on a far side of the reference boundary line. When the travel path is determined to be in the obstacle overlapping state, the vehicle control apparatus sets an offset boundary line by offsetting the reference boundary line to an inner side in a lateral direction of the road and performs the deviation suppression control based on the offset boundary line.

### CROSS-REFERENCE TO RELATED APPLICATIONS

This application is based on and claims the benefit of priority from Japanese Patent Application No. 2024-207588, filed on Nov. 28, 2024. The entire disclosure of the above application is incorporated herein by reference.

### BACKGROUND

The present disclosure relates to a vehicle control apparatus and a program.

As travel assistance control for a vehicle, a technology is known that performs control to prevent the vehicle from deviating from a travel lane when traveling on a road and control to prevent the vehicle from colliding with an obstacle present on a roadside.

### SUMMARY

An aspect of the present disclosure provides a vehicle control apparatus configured to perform deviation suppression control to prevent a vehicle from deviating outside left and right reference boundary lines when traveling on a road, in which the reference boundary line is either of road boundary lines that are left and right road edges of the road, and left and right boundary lines of a travel lane in the road. The vehicle control apparatus sets a travel path ahead of the vehicle in a travelling direction. The vehicle control apparatus recognizes presence of an obstacle ahead of the vehicle. In response to an object being recognized as being present ahead of the vehicle, the vehicle control apparatus determines whether the travel path is in an obstacle overlapping state intersecting the reference boundary line and overlapping the obstacle on a far side of the reference boundary line. In response to the travel path being determined to be in the obstacle overlapping state, the vehicle control apparatus sets an offset boundary line by offsetting the reference boundary line to an inner side in a lateral direction of the road and performs the deviation suppression control based on the offset boundary line.

### BRIEF DESCRIPTION OF THE DRAWINGS

In the accompanying drawings:

FIG. 1 is a configuration diagram illustrating an overview of a travel assistance system of a vehicle;

FIG. 2 is a plan view of a road showing an example of a travel scene in which lane deviation of the vehicle may occur;

FIG. 3 is a plan view of a road showing an example of a travel scene in which lane deviation of the vehicle may occur;

FIG. 4 is a diagram illustrating a relationship between a clearance D2 and an offset amount;

FIG. 5 is a diagram illustrating a relationship between an angle θ, a vehicle speed, and the offset amount;

FIG. 6 is a flowchart illustrating processing steps for deviation suppression control;

FIG. 7 is a diagram illustrating a travel scene in which the vehicle travels on a road including an intersection;

FIG. 8 is a flowchart illustrating steps for setting an offset section;

FIG. 9 is a plan view of a road showing a travel scene in which the vehicle travels on a curved road;

FIG. 10 is a flowchart of processing steps for deviation suppression control according to a second embodiment;

FIG. 11 is a diagram illustrating a relationship between the clearance D2 and the offset amount;

FIG. 12 is a diagram illustrating a relationship between the angle θ and the offset amount;

FIG. 13 is a plan view of a road showing a state in which an obstacle is present on a side of a travel lane; and

FIG. 14 is a flowchart illustrating processing steps for deviation suppression control according to a third embodiment.

### DESCRIPTION OF THE EMBODIMENTS

Embodiments of the present disclosure relate to a vehicle control apparatus that provides travel assistance for a vehicle, and a program.

For example, JP 2017-226393 A discloses a technology in which collision avoidance assistance control is started at an appropriate timing when, on a road in which a continuous obstacle such as a guardrail or a side wall is present on a side of a traffic lane, a vehicle opposes the continuous obstacle ahead of the vehicle in a travelling direction on a curved road or like.

Incidentally, in deviation suppression control to prevent a vehicle from deviating from a travel lane, lane deviation is suppressed by steering control of the vehicle or the like when the vehicle shifts toward either of a left side and a right side of the travel lane. As a result of the deviation suppression control, in a case in which a structure such as a guardrail or a side wall is present on an outer side of the travel lane, a situation in which the vehicle comes into contact with the guardrail or the like can be prevented by lane deviation being suppressed. However, in this case, even if contact with the guardrail or the like is prevented as a result, anxiety experienced by a vehicle occupant is thought to increase due to the vehicle approaching the guardrail or the like. In this regard, it is thought that there is room for improvement in deviation suppression control.

It is thus desired to provide a vehicle control apparatus capable of allowing deviation suppression control to be appropriately performed when a vehicle is traveling on a road, and a program.

An exemplary embodiment of the present disclosure provides a vehicle control apparatus that performs deviation suppression control to prevent a vehicle from deviating outside left and right reference boundary lines when traveling on a road, in which the reference boundary line being either of road boundary lines that are left and right road edges of the road, and left and right boundary lines of a travel lane in the road. The vehicle control apparatus includes a travel path setting unit, an overlap determination unit, and a control unit. The travel path setting unit sets a travel path ahead of the vehicle in a travelling direction; an obstacle recognition unit that recognizes presence of an obstacle ahead of the vehicle. In response to an object being recognized as being present ahead of the vehicle, the overlap determination unit determines whether the travel path is in an obstacle overlapping state intersecting the reference boundary line and overlapping the obstacle on a far side of the reference boundary line. In response to the travel path being determined to be in the obstacle overlapping state, the control unit sets an offset boundary line by offsetting the reference boundary line to an inner side in a lateral direction of the road and performs the deviation suppression control based on the offset boundary line.

When the deviation suppression control is performed, if an obstacle composed of any of a guardrail, a side wall, or a building is present on the outer side of a reference boundary line serving as reference for the deviation suppression control, likelihood of contact with the obstacle arises when the vehicle deviates from the travel lane or the like. In addition, anxiety experienced by a vehicle occupant is thought to increase due to the vehicle approaching the obstacle. In this regard, as a result of the above-described configuration, when the obstacle is present ahead of the vehicle, the travel path of the vehicle is determined to be in the obstacle overlapping state intersecting the reference boundary line and overlapping the obstacle on the far side of the reference boundary line. Then, when the travel path is determined to be in the obstacle overlapping state, the offset boundary line is set by the reference boundary line being offset to the inner side in the lateral direction of the road. In addition, the deviation suppression control is performed based on the offset boundary line. As a result, when the obstacle is present on the outer side of the reference boundary line, the anxiety experienced by the vehicle occupant due to the vehicle approaching the obstacle can be reduced while deviation suppression of the vehicle is implemented. When the obstacle is not present on the outer side of the reference boundary line, excessive deviation suppression is suppressed. Consequently, the deviation suppression control can be appropriately performed when the vehicle travels on a road.

Embodiments implementing a vehicle control apparatus of the present disclosure will hereinafter be described with reference to the drawings. According to the embodiments, for example, a travel assistance system that provides vehicle travel assistance to a vehicle such as a passenger vehicle, a truck, or a bus is provided.

### First Embodiment

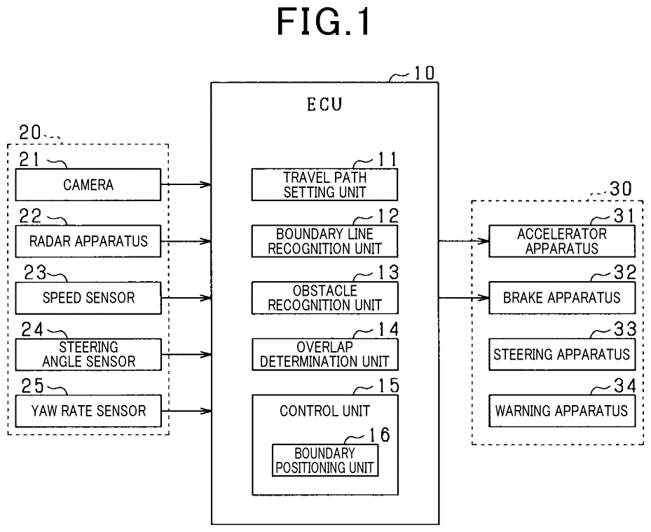

As shown in FIG. 1, a travel assistance system according to a first embodiment includes an electronic control unit (ECU) 10 serving as a vehicle control apparatus, sensors 20, and a controlled apparatus 30. The sensors 20 include a camera 21, a radar apparatus 22, a speed sensor 23, a steering angle sensor 24, and a yaw rate sensor 25. The camera 21 and the radar apparatus 22 correspond to an object detection apparatus that detects an object in a vehicle vicinity. The controlled apparatus 30 includes an accelerator apparatus 31, a brake apparatus 32, a steering apparatus 33, and a warning apparatus 34.

For example, the camera 21 may be a monocular camera. The camera 21 is a plurality of imaging apparatuses capable of capturing images of areas ahead of, behind, and to both left and right sides of the vehicle. The cameras 21 capture images of the vehicle vicinity. The camera 21 that captures the area ahead of the vehicle is provided near a front bumper of the vehicle or in an upper portion of a front windshield of the vehicle. Each camera 21 transmits the captured image to the ECU 10 at a predetermined cycle. Here, the camera 21 may also be a stereo camera.

The radar apparatus 22 is a distance measurement apparatus using millimeter-wave, high-frequency signals as transmission waves. For example, the radar apparatus 22 may be mounted in each of a front end, a rear end, and both left and right side surfaces of the vehicle, and measures a distance to an object in the vehicle vicinity. Specifically, the radar apparatus 22 transmits a probe wave at a predetermined cycle, receives a reflected wave through a plurality of antennas, and measures the distance to the object based on a transmission time of the probe wave and a reception time of the reflected wave. In addition, the radar apparatus 22 calculates an orientation of the object from a phase difference between the reflected waves received by the plurality of antennas. A relative position of the object to the own vehicle can be identified by the distance to the object and the orientation of the object being calculated.

The speed sensor 23 detects a travel speed of the own vehicle. For example, a wheel speed sensor that detects a rotation speed of a wheel can be used as the speed sensor 23. The steering angle sensor 24 detects a steering angle of a steering member of the vehicle. The yaw rate sensor 25 detects a yaw rate that is a lateral acceleration in a lateral direction of the vehicle.

The accelerator apparatus 31 is an engine or a motor serving as a driving power source for the vehicle. During accelerator operation by a driver, the accelerator apparatus 31 is driven by a control command from the ECU 10 and applies driving force for vehicle travel. The brake apparatus 32 is provided in each wheel of the vehicle. During brake operation by the driver, the brake apparatus 32 is operated by a control command from the ECU 10 and applies braking force to the vehicle.

The steering apparatus 33 is a motor for steering the vehicle. For example, during a turning operation by the driver, the steering apparatus 33 may be operated by a control command from ECU 10 and turns the vehicle. The warning apparatus 34 is a display apparatus enabling display or a speaker enabling voice notification. The warning apparatus 34 notifies the driver of a state of the vehicle, a state of the vehicle vicinity, a state in which travel safety of the vehicle is impaired, and the like.

The ECU 10 is an electronic control apparatus including a well-known microcomputer composed of a central processing unit (CPU) serving as a processor, a read-only memory (ROM), a random access memory (RAM), a flash memory, and the like. The microcomputer provides various types of computation functions. The functions provided by the microcomputer can be provided by software recorded in a tangible memory apparatus and a computer that runs the software, software alone, hardware alone, or a combination thereof. For example, the microcomputer may execute a program stored in a non-transitory, tangible storage medium serving as a storage unit provided in the microcomputer itself. For example, the program may include programs related to an object recognition process for recognizing an object in the vehicle vicinity, a process for avoiding a collision with the object in the vehicle vicinity or mitigating damage during a collision, and a process for controlling the travel speed of the vehicle. A method corresponding to the program is performed by the microcomputer running the program. The storage unit is, for example, a non-volatile memory. Here, for example, the program stored in the storage unit can be updated over a network such as the Internet.

The ECU 10 acquires object detection information from each of the cameras 21 and the radar apparatuses 22, and recognizes an object in the vehicle vicinity based on these pieces of information. Specifically, the ECU 10 calculates a relative position, a presence region, and the like of the object as image information, from the distance to the object and the orientation of the object calculated from the camera image. In addition, the ECU 10 calculates the relative position, the presence region, and the like of the object as radar information, from the distance to the object and the orientation of the object included in distance information acquired from the radar apparatus 22. The ECU 10 then recognizes the object by integrating (fusing) the image information and the radar information. At this time, the object is recognized based on overlapping of the presence region of the object included in the image information and the presence region of the object included in the radar information. However, according to the present embodiment, a method for object recognition is arbitrary. For example, the object can be recognized based on the object detection information from the camera 21 alone or the object detection information from the radar apparatus 22 alone, of the object detection information from the camera 21 and the radar apparatus 22.

The ECU 10 performs collision suppression control (pre-crash safety (PCS)) and lane deviation suppression control (lane departure alert (LDA)) as the travel assistance control for the vehicle. Specifically, as the collision suppression control, the ECU 10 calculates a time-to-collision (TCC) that is an amount of time before the vehicle and an object collide, based on the relative distance and relative speed between the vehicle and the object. The ECU 10 also performs collision avoidance control for avoiding a collision based on a comparison between a predicted collision time and an operation timing. At this time, the ECU 10 brakes the vehicle using the braking apparatus 32 included in the controlled apparatus 30 and avoids the collision with the object. The ECU 10 can also avoid the collision with the object by performing automatic steering of the vehicle using the steering apparatus 33. Alternatively, the ECU 10 can notify the driver that there is a risk of collision using the warning apparatus 34. Here, the operation timing is a timing at which the controlled apparatus 30 and the like are to be operated. The operation timing may be set for each target to be operated.

In addition, as the deviation suppression control, the ECU 10 performs turning control of the vehicle using the steering apparatus 33 to suppress lane deviation when the vehicle is about to deviate from a travel lane (own lane). In this case, the ECU 10 uses left and right boundary lines of the travel lane as reference boundary lines, and suppresses the vehicle from running outside the reference boundary lines (outer sides of the travel lane) based on the reference boundary lines and a vehicle position. As the deviation suppression control, the ECU 10 may perform a deviation suppression process in which lane deviation is suppressed through turning control by the steering apparatus 33 or a deviation suppression process in which lane deviation is suppressed through a warning issued to the driver by the warning apparatus 34.

Instead of using the boundary lines on both left and right sides of the travel lane as the reference boundary lines, the deviation suppression control may be performed using road boundary lines that are left and right road edges of a road as the reference boundary lines. For example, the road edge may be a curb or a pavement border position. In this case, the ECU 10 recognizes the left and right road edges, and performs the deviation suppression control such that the vehicle does not deviate outside the left and right road edges. In the deviation suppression control, either of the left and right reference boundary lines can be the boundary line and the other reference boundary line can be the road edge.

Here, if a structure such as a guardrail, a side wall, or a building is present on the outer side of the travel lane in which the vehicle is traveling, the vehicle may come into contact with the guardrail or the like when running outside the boundary line that is the reference boundary line. In addition, if the vehicle shifts too close to one side of the travel lane, a vehicle occupant may experience increased anxiety due to the presence of the guardrail or the like. Therefore, according to the present embodiment, in the deviation suppression control for the vehicle, in a case in which an obstacle is present on the outer side of the reference boundary line, the configuration is such that an offset boundary line is prescribed by offsetting the reference boundary line to the inner side of the travel lane. The deviation suppression control is performed based on the offset boundary line.

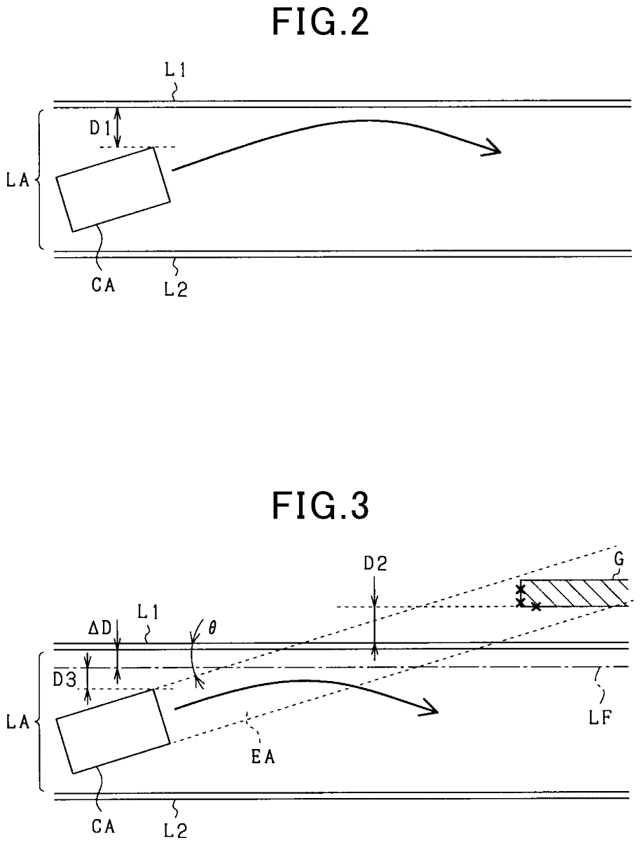

FIG. 2 is a plan view of a road showing an example of a travel scene in which lane deviation of a vehicle CA may occur. In FIG. 2, the road includes a travel lane LA (own lane) in which the vehicle CA is traveling. Boundary lines L1 and L2 that are a white line, a yellow line, or the like, are drawn on the left and right sides of the travel lane LA. In this travel scene, a lateral distance D1 between an end portion on either of the left and right of the vehicle CA, and the boundary line L1 or L2 is calculated. When the lateral distance D1 is shorter than a predetermined distance threshold TH1, automatic steering by the steering apparatus 33 or warning by the warning apparatus 34 is performed as the deviation suppression process. FIG. 2 shows a state in which the vehicle CA returns to the center of the travel lane LA by automatic steering by the steering apparatus 33 or manual steering by the driver after approaching the left boundary line L1.

For example, the lateral distance D1 may be a distance between a portion of the vehicle CA closest to the boundary line L1 or L2, and the corresponding boundary line L1 or L2. However, the lateral distance D1 may be a distance between a center portion of a front wheel and the boundary line L1 or L2. A position on the boundary line L1 or L2 serving as reference may be an edge position inside or outside the travel lane LA, or a center position in a width direction of the boundary line L1 or L2.

FIG. 3 is a plan view of a road showing an example of a travel scene in which lane deviation of the vehicle CA may occur on a road on which an obstacle G such as a guardrail is present on the outer side of the travel lane LA.

In FIG. 3, a path area EA that is a travel path of the vehicle CA and has a lateral width of the vehicle CA is set ahead of the vehicle CA in a travelling direction. In addition, the obstacle G is present on the outer side of the left boundary line L1 of the travel lane LA ahead of the vehicle CA. A clearance in a lateral direction of the road from the boundary line L1 to the obstacle G outside the lane LA is D2. The clearance D2 is a distance at a position closest to the boundary line L1, on an outer surface of the obstacle G intersecting the path area EA. An angle at which the travelling direction of the vehicle CA intersects the boundary line L1 is θ. The path area EA intersects the boundary line L1 at the angle θ. In this case, an offset boundary line LF is set by the boundary line L1 being offset to the inner side of the travel lane LA. In FIG. 3, the offset boundary line LF is a virtual line obtained by the boundary line L1 being offset to the inner side of the travel lane LA by an offset amount ΔD.

The deviation suppression process is then performed based on the offset boundary line LF. In this case, a lateral distance D3 between the end portion on either of the left and right of the vehicle CA and the offset boundary line LF is calculated. When the lateral distance D3 is shorter than the predetermined distance threshold TH1, automatic steering by the steering apparatus 33 or warning by the warning apparatus 34 is performed as the deviation suppression process.

A configuration of the ECU 10 related to the deviation suppression control will be described. Here, in the description hereafter, the ECU 10 is configured to recognize the left and right boundary lines L1 and L2 (such as white lines) of the travel lane LA as the reference boundary lines. In FIG. 1, the ECU 10 includes a travel path setting unit 11, a boundary line recognition unit 12, an obstacle recognition unit 13, an overlap determination unit 14, and a control unit 15.

The travel path setting unit 11 sets the travel path ahead of the vehicle CA in the travelling direction. The travel path is a predicted trajectory on which the vehicle CA is predicted to subsequently travel. The travel path may be set based on the steering angle and the yaw rate of the vehicle CA ahead of the vehicle CA in the travelling direction. In this case, the travel path is set to a linear shape if the steering angle and the yaw rate are zero when the vehicle CA is traveling straight ahead. In addition, the travel path is set to a curved shape based on the steering angle and the yaw rate of the vehicle CA when the vehicle CA turns. According to the present embodiment, as the travel path of the vehicle CA, the path area EA that extends along the predicted travelling direction of the vehicle CA and has the lateral width of the vehicle CA is set.

However, when the path area EA is set as the travel path of the vehicle CA, the lateral width of the path area EA is not necessarily required to be identical to the lateral width (vehicle width) of the vehicle CA and may be narrower than the vehicle width. Alternatively, the lateral width of the path area EA may be wider than the vehicle width. The configuration may be such that, as the travel path of the vehicle CA, an estimated radius is set based on the travel speed and the yaw rate of the vehicle CA.

The boundary line recognition unit 12 recognizes the left and right boundary lines L1 and L2 of the travel lane LA of the vehicle CA. At this time, the boundary lines L1 and L2 may be recognized based on changes in luminance in an image, using the image captured by the camera 12. Specifically, the ECU 10 extracts a point of change in contrast (luminance value) on a road surface as an edge point for the boundary line such as a white line demarcating a traffic lane on a road surface. Then, the ECU 10 recognizes the boundary line from an edge point row connecting the extracted edge points.

The obstacle recognition unit 13 recognizes the presence of the obstacle G ahead of the vehicle CA. For example, the ECU 10 may recognize the obstacle G based on object detection information based on captured images from the camera 21 and object detection information from the radar apparatus 22. In this case, the obstacle G may be recognized by pattern matching of individual objects using camera images. Alternatively, the obstacle G may be recognized by reflection points of the transmission waves of the radar apparatus 22.

The overlap determination unit 14 determines whether the path area EA is in an obstacle overlapping state intersecting the boundary line L1 or L2 and overlapping the obstacle G on a far side of the boundary line L1 or L2, when the obstacle G is recognized as being present ahead of the vehicle CA. For example, in the travel scene shown in FIG. 3, the obstacle G may be present on a side opposite the vehicle LA with the boundary line L1 therebetween (that is, the far side of the boundary line L1), and the path area EA may be determined to be in the obstacle overlapping state.

When the overlap determination unit 14 determines that the path area EA is in the obstacle overlapping state, the control unit 15 sets the offset boundary line LF by offsetting the boundary line L1 or L2 to the inner side of the travel lane LA (inner side in the lateral direction of the road), and performs the deviation suppression process based on the offset boundary line LF. The offset amount ΔD for setting the offset boundary line LF is a fixed value. Specifically, the offset amount ΔD is about a hundred to several hundred millimeters.

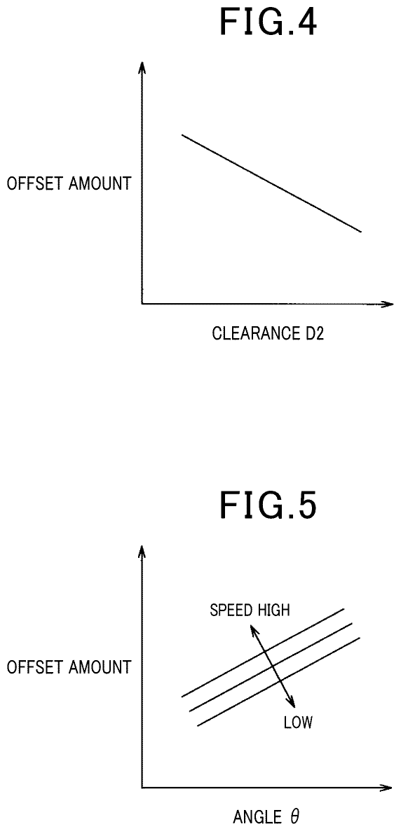

The control unit 15 may have a boundary positioning unit 16 that determines the position of the offset boundary line LF. The boundary positioning unit 16 variably determines the position of the offset boundary line LF by setting the offset amount ΔD to be variable. Specifically, the boundary positioning unit 16 may use a relationship shown in FIG. 4, for example, and sets the offset amount ΔD based on the clearance D2 (see FIG. 3) in the lateral direction of the road between the boundary line L1 or L2 on the obstacle G side and the obstacle G. In FIG. 4, the offset amount ΔD is set to a greater value as the clearance D2 decreases.

Alternatively, the boundary positioning unit 16 may use a relationship shown in FIG. 5, for example, and sets the offset amount ΔD based on the angle θ (see FIG. 3) at which the travelling direction of the vehicle CA intersects the boundary line L1 or L2 and the travel speed of the vehicle CA. In FIG. 5, the offset amount ΔD is set to a greater value as the angle θ increases. In addition, the offset amount ΔD is set to a greater value as the travel speed of the vehicle CA increases. Here, the offset amount ΔD can also be set based on either of the angle θ and the travel speed of the vehicle CA.

When the offset amount ΔD is set based on the relationships in FIG. 4 and FIG. 5, the offset boundary line LF may be set using the greater of the offset amount ΔD set based on the relationship in FIG. 4 and the offset amount ΔD set based on the relationship in FIG. 5.

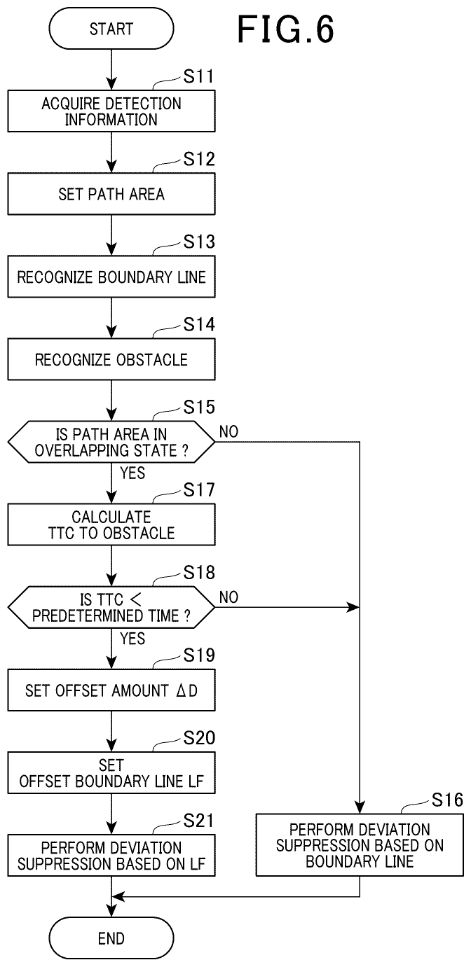

FIG. 6 is a flowchart of processing steps for the deviation suppression control. The present process is repeatedly performed by the ECU 10 at a predetermined cycle.

In FIG. 6, at step S11, the ECU 10 acquires detection information from the camera 21, the radar apparatus 22, the speed sensor 23, the steering angle sensor 24, the yaw rate sensor 25, and the like. At step S12, the ECU 10 sets the path area EA (travel path) ahead of the vehicle CA in the travelling direction based on the steering angle, the yaw rate, and the like of the vehicle CA.

At step S13, the ECU 10 recognizes the left and right boundary lines L1 and L2 of the travel lane LA in which the vehicle CA is traveling. At this time, for example, the ECU 10 may recognize the boundary lines L1 and L2 on the left and right of the travel lane LA based on the captured image from the camera 21, and set the boundary lines L1 and L2 as the left and right reference boundary lines.

At step S14, the ECU 10 performs the object recognition process for objects ahead of the vehicle CA based the detection information from the camera 21 and the radar apparatus 22. As a result, the ECU 10 recognizes various types of obstacles G present ahead of the vehicle CA. For example, when the obstacle G such as a guardrail is present ahead of the vehicle CA, the ECU 10 may recognize the presence of the obstacle G from the captured image from the camera 21.

At step S15, the ECU 10 determines whether the path area EA of the vehicle CA is in the obstacle overlapping state intersecting the boundary line L1 or L2 and overlapping the obstacle G on the far side of the boundary line L1 or L2. Then, when determined that the path area EA is not in the obstacle overlapping state, the ECU 10 proceeds to step S16. When determined that the path area EA is in the obstacle overlapping state, the ECU 10 proceeds to step S17.

At step S16, the ECU 10 performs the deviation suppression control based on the boundary lines L1 and L2 that are the reference boundary lines. At this time, the ECU 10 compares the lateral distances D1 between the end portions on the left and right of the vehicle CA and the boundary lines L1 and L2, and the distance threshold TH1. When the lateral distance D1 is shorter than the distance threshold TH1, the ECU 10 performs automatic steering by the steering apparatus 33 or issues a warning from the warning apparatus 34 as the deviation suppression process.

At step S17, the ECU 10 calculates the TTC at a recognition point closest to the vehicle CA on the obstacle G present in the path area EA of the vehicle CA. At subsequent step S18, the ECU 10 determines whether the TTC calculated at step S17 is within a predetermined amount of time. For example, the predetermined amount of time may be about 2 seconds. Then, when determined that the TTC is not within the predetermined amount of time, the ECU 10 proceeds to step S16. When determined that the TTC is within the predetermined amount of time, the ECU 10 proceeds to step S19. At step S16, the ECU 10 performs the deviation suppression control based on the offset boundary line LF.

Here, at steps S17 and S18, the processes are performed to determine whether the TTC of the obstacle G present in the path area EA is within a predetermined amount of time. However, instead, the process can be performed to determine whether the distance from the vehicle CA to the obstacle G present in the path area EA is within a predetermined distance. Steps S17 and S18 can also be omitted.

At step S19, the ECU 10 sets the offset amount ΔD by which the boundary line L1 or L2 on the obstacle G side is offset to the inner side of the travel lane LA. For example, the offset amount ΔD may be a fixed value. Alternatively, the offset amount ΔD may be a variable value that is variably set. In this case, the ECU 10 sets the offset amount ΔD based on the clearance D2 from the boundary line L1 or L2 to the obstacle G outside the travel lane LA, using the relationship shown in FIG. 4. Alternatively, the ECU 10 sets the offset amount ΔD based on the angle θ at which the travelling direction of the vehicle CA intersects the boundary line L1 or L2 and the travel speed of the vehicle CA, using the relationship shown in FIG. 5.

Then, at step S20, the ECU 10 offsets the boundary line L1 or L2 on the obstacle G side to the inner side of the road in the lateral direction based on the offset amount ΔD set at step S19, and sets the offset boundary line LF.

Then, at step S21, the ECU 10 performs the deviation suppression control based on the offset boundary line LF. At this time, the ECU 10 compares the lateral distance D3 between the left or right end portion of the vehicle CA and the offset boundary line LF, and the distance threshold TH1. When the lateral distance D3 is shorter than the distance threshold TH1, the ECU 10 performs automatic steering by the steering apparatus 33 or issues a warning from the warning apparatus 34 as the deviation suppression process. Here, of the left and right sides of the travel lane TA, on the side opposite the offset boundary line LF, the ECU 10 performs the deviation suppression control based on the boundary line L1 or L2 that is the reference boundary line, in a manner identical to the deviation suppression control that is ordinarily performed.

According to the present embodiment described in detail above, excellent effects below can be achieved.

When the path area EA of the vehicle CA is in the obstacle overlapping state intersecting the boundary line L1 or L2 and overlapping the obstacle G on the far side of the boundary line L1 or L2, the corresponding boundary line L1 or L2 is offset to the inner side of the road in the lateral direction and the offset boundary line LF is set. The deviation suppression control is then performed based on the offset boundary line LF. As a result, when the obstacle G is present on the outer side of the boundary line L1 or L2 of the travel lane LA, anxiety experienced by the vehicle occupant due to the vehicle CA approaching the obstacle G can be reduced while deviation suppression of the vehicle CA is implemented. When the obstacle G is not present on the outer side of the boundary line L1 or L2, excessive deviation suppression is suppressed. Consequently, the deviation suppression control is appropriately performed when the vehicle CA travels on a road.

When the path area EA of the vehicle CA is in the obstacle overlapping state intersecting the boundary line L1 or L2 that is the reference boundary line and overlapping the obstacle G on the far side of the boundary line L1 or L2, likelihood of the vehicle CA coming into contact with the obstacle G increases as the clearance D2 between the boundary line L1 or L2 and the obstacle G in the lateral direction of the vehicle CA decreases. Taking this point into consideration, a more appropriate deviation suppression control can be implemented by the position of the offset boundary line LF being determined based on the clearance D2 between the boundary line L1 or L2 and the obstacle G in the lateral direction of the vehicle.

When the path area EA of the vehicle CA is in the obstacle overlapping state intersecting the boundary line (reference boundary line) and overlapping the obstacle G on the far side of the boundary line, likelihood of the vehicle CA coming into contact with the obstacle G increases as the angle θ between the travelling direction of the vehicle CA and the boundary line increases or the vehicle speed increases. Taking this point into consideration, a more appropriate deviation suppression control can be implemented by the position of the offset boundary line LF being determined based on the angle θ or the vehicle speed.

### Variation Examples According to the First Embodiment

When the path area EA of the vehicle CA is determined to be in the obstacle overlapping state, the offset boundary line LF may be set to be extended over a predetermined section ahead of the vehicle CA in the travelling direction, even after the vehicle CA passes the side of the obstacle G.

Specifically, the ECU 10 sets an extension of the offset boundary line LF at step S20 in FIG. 6. At this time, a state in which the offset boundary line LF is valid continues for an offset duration from a current point in time until elapse of a predetermined amount of time. For example, the offset duration may be prescribed to be a predetermined amount of time from about 10 seconds to several minutes. Alternatively, for example, the offset duration may be prescribed to be a predetermined distance from about 10 to several tens of meters. In this case, after the path area EA of the vehicle CA is determined not to be in the obstacle overlapping state, the offset boundary line LF becomes invalid upon elapse of the offset duration.

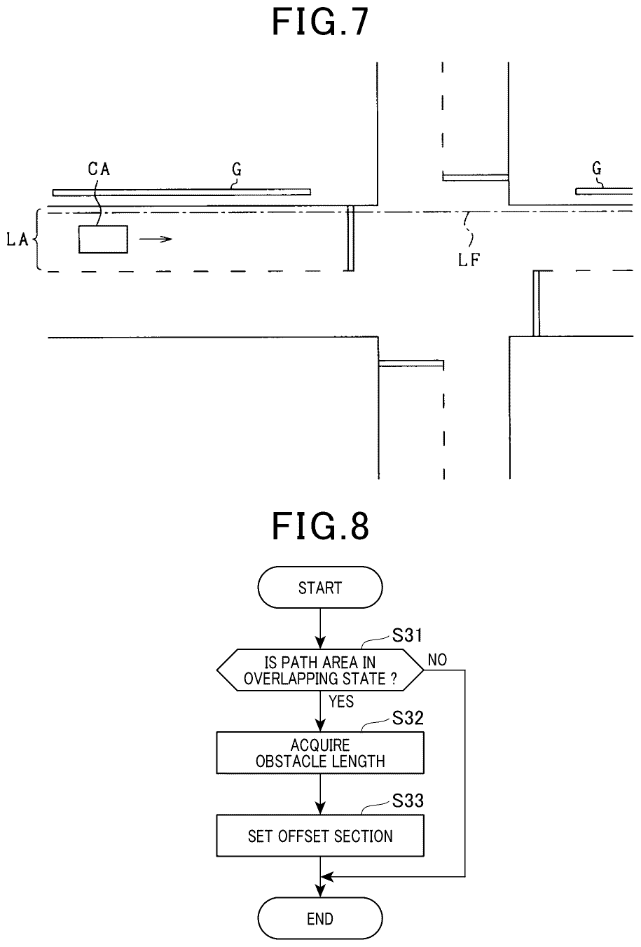

FIG. 7 is a diagram of a travel scene in which the vehicle CA travels on a road including an intersection. In FIG. 7, the vehicle CA is traveling in the travel lane LA before the intersection. The obstacle G that is a guardrail is present on the left side of the travel lane LA. In this case, the reference boundary line such as the boundary line is temporarily interrupted at the intersection. However, through extension of the offset boundary line LF, the offset boundary line LF is set to span the intersection. Therefore, the deviation suppression control is performed based on the offset boundary line LF even after the vehicle CA passes the side of obstacle G. As a result, even in cases in which the obstacle G such as a continuous structure is absent in a portion of a section, such as the intersection, the appropriate deviation suppression control can be performed as a result of the offset boundary line LF that is a virtual boundary.

An extension duration over which the offset boundary line LF is extended ahead of the vehicle CA in the travelling direction can also be variably set. For example, the ECU 10 can acquire obstacle length information that is information on a length of the obstacle G in the direction along the road. The ECU 10 may then set the extension duration of the offset boundary line LF based on the obstacle length.

For example, the ECU 10 may perform a process shown in FIG. 8. In FIG. 8, at step S31, the ECU 10 determines whether the path area EA of the vehicle CA is in the obstacle overlapping state intersecting the boundary line and overlapping the obstacle G on the far side of the boundary line. Then, when determined that the path area EA of the vehicle CA is in the obstacle overlapping state, the ECU 10 proceeds to step S32. At step S32, the ECU 10 acquires the obstacle length information. For example, the obstacle length information may indicate an object type of the obstacle G. In this case, the obstacle length information may include information on whether the obstacle G is a continuous structure such as a guardrail that extends in the travelling direction of the vehicle CA or an obstacle that is not a continuous structure, such as a pedestrian or a bicycle. The obstacle length information may be information on a length dimension in the travelling direction of the vehicle. For example, the obstacle length information may be recognized from a captured image from the camera 21 or distance measurement data from the radar apparatus 22.

Then, at step S33, the ECU 10 sets the extension duration of the offset boundary line LF based on the obstacle length information. At this time, if the obstacle G is a guardrail or the like that has a length in the travelling direction of the vehicle CA that is equal to or greater than a predetermined length, the ECU 10 sets a relatively long extension duration. If the obstacle G has a length in the travelling direction of the vehicle CA that is less than the predetermined length, the ECU 10 sets a relatively short extension duration.

Other embodiments in which the above-described first embodiment is partially modified will be described, focusing mainly on differences from the first embodiment.

### Second Embodiment

According to a second embodiment, the configuration is such that differing offset boundary line lines LF are set based on whether the road on which the vehicle CA is traveling is a straight road or a curved road.

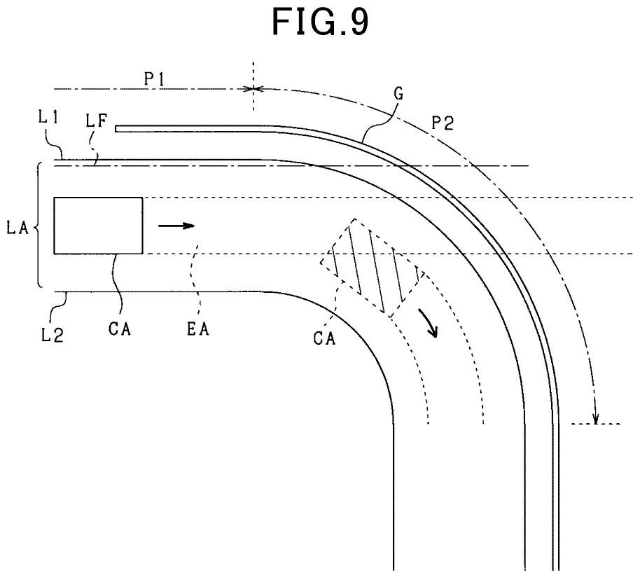

FIG. 9 is a plan view of a road showing a travel scene in which the vehicle CA travels on a curved road. The curved road has a straight portion P1 and a curved portion P2. In the scene in FIG. 9, the vehicle CA is traveling in the straight portion P1. In addition, the curved road has a rightward curve. The obstacle G that is a guardrail is present along the curved road on the outer side of the boundary line L1 on the left side of the travel lane LA.

In the state in FIG. 9, the vehicle CA is traveling in the straight portion P1, and the path area EA is set in a linear shape ahead of the vehicle CA. Therefore, the path area EA is in the obstacle overlapping state intersecting the boundary line L1 on the left side and overlapping the obstacle G on the far side of the boundary line L1. In this case, the offset boundary line LF is set on the inner side of the travel lane LA from the boundary line L1.

Subsequently, when the vehicle CA travels to the curved portion P2, the path area EA is set in a curved shape based on a turning state of the vehicle CA. Therefore, the state in which the path area EA intersects the boundary line L1 is canceled. However, in this case, depending on setting accuracy of the path area EA, recognition accuracy of the boundary line, and the like, the path area EA being in a state (obstacle overlapping state) intersecting the boundary line L1 of the road (curved road) and overlapping the obstacle on the far side of the boundary line L1 can be considered. Under this circumstance, the offset boundary line LF being excessively set on the inner side of the travel lane LA and the deviation suppression control being unnecessarily performed is a concern.

Therefore, according to the present embodiment, a travel scene in which the road ahead of the vehicle CA is a straight road and the path area EA is in the obstacle overlapping state on the straight road is a first travel scene. A travel scene in which the road ahead of the vehicle CA is a curved road and the path area EA is in the obstacle overlapping state on the curved road is a second travel scene. The travel scene in FIG. 9 is the second travel scene. Then, when the travel scene is determined to be the second travel scene, a second offset boundary line having the offset amount ΔD that is less than that of a first offset boundary line when the travel scene is determined to be the first travel scene is set.

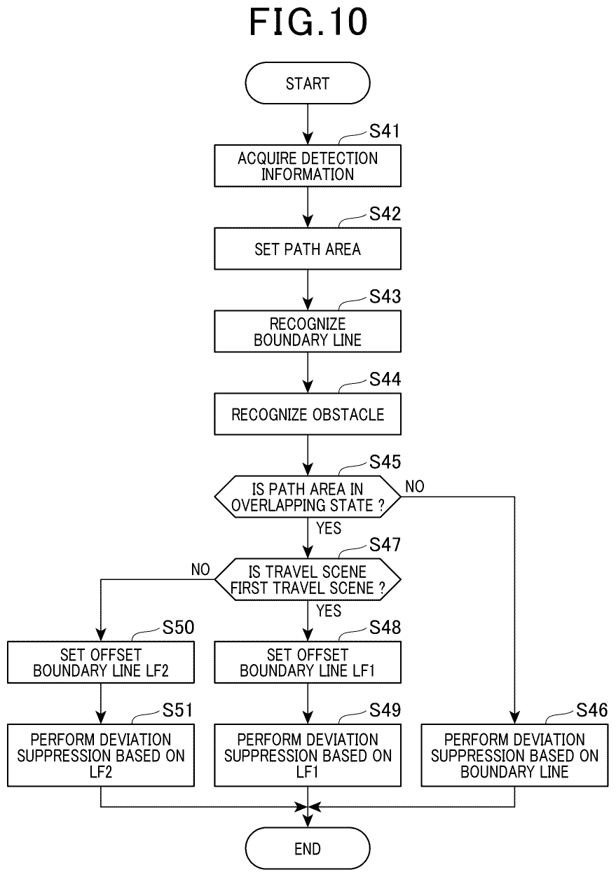

FIG. 10 is a flowchart of processing steps for deviation suppression control according to the present embodiment. The present process is repeatedly performed by the ECU 10 at a predetermined cycle.

In FIG. 10, steps S41 to S46 are processes identical to steps S11 to S16 in FIG. 6. These processes are briefly described herein. At step S41, the ECU 10 acquires detection information from the camera 21, the radar apparatus 22, the speed sensor 23, the steering angle sensor 24, the yaw rate sensor 25, and the like. At step S42, the ECU 10 sets the path area EA (travel path) ahead of the vehicle CA in the travelling direction based on the steering angle, the yaw rate, and the like of the vehicle CA. At step S43, the ECU 10 recognizes the left and right boundary lines L1 and L2 of the travel lane LA. At step S44, the ECU 10 recognizes various obstacles G present ahead of the vehicle CA by the object recognition process for objects ahead of the vehicle CA.

At step S45, the ECU 10 determines whether the path area EA of the vehicle CA is in the obstacle overlapping state intersecting the boundary line L1 or L2 and overlapping the obstacle G on the far side of the boundary line L1 or L2. Then, when determined that the path area EA of the vehicle CA is not in the obstacle overlapping state, the ECU 10 proceeds to step S46 and performs the deviation suppression control based on the boundary lines L1 and L2 that are the reference boundary lines.

In addition, when determined that the path area EA of the vehicle CA is in the obstacle overlapping state, the ECU 10 proceeds to step S47. At step S47, the ECU 10 determines whether a current travel scene of the vehicle CA is the first travel scene (corresponding to a scene determination unit). Then, when determined that the travel scene is the first travel scene, the ECU 10 determines YES at step S47 and proceeds to step S48. When determined that the travel scene is the second travel scene, the ECU 10 determines NO at step S47 and proceeds to step S50.

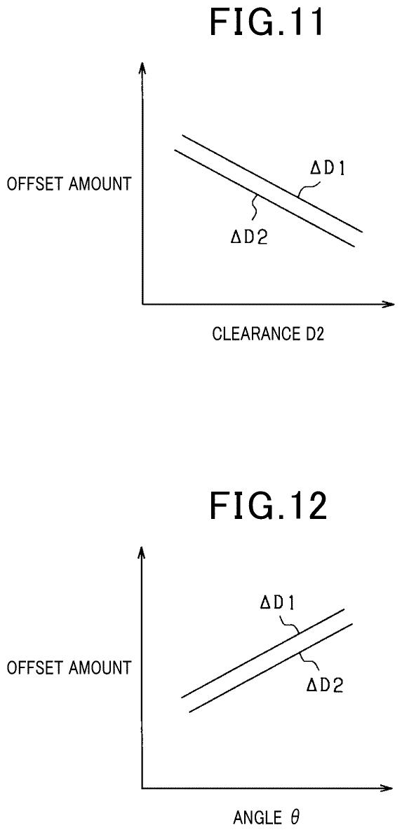

At step S48, the ECU 10 sets the first offset boundary line LF1 as the offset boundary line. At this time, the ECU 10 sets a first offset boundary line LF1 by offsetting the boundary line on the obstacle G side, of the left and right boundary lines L1 and L2, to the inner side in the lateral direction of the road based on an offset amount ΔD1. For example, the offset amount ΔD1 may be set based on a relationship in FIG. 11 or FIG. 12. In FIG. 11, the offset amount ΔD1 is set based on the clearance D2 from the boundary line L1 or L2 to the obstacle G on the outside of the travel lane LA. In addition, in FIG. 12, the offset amount ΔD1 is set based on the angle θ at which the travelling direction of the vehicle CA intersects the boundary line L1 or L2. In addition, in a manner similar to that in FIG. 5, in FIG. 12, a relationship between the angle θ, the driving speed of the vehicle CA, and the offset amount ΔD1 may be prescribed.

Then, at step S49, the ECU 10 performs the deviation suppression control based on the first offset boundary line LF1. At this time, the ECU 10 performs automatic steering by the steering apparatus 33 or issues a warning from the warning apparatus 34 as the deviation suppression process based on a result of a comparison of a lateral distance between the left or right end portion of the vehicle CA and the first offset boundary line LF1, to the distance threshold TH1.

Meanwhile, at step S50, the ECU 10 sets a second offset boundary line LF2 as the offset boundary line. At this time, the ECU 10 sets the second offset boundary line LF2 by offsetting the boundary line on the obstacle G side, of the left and right boundary lines L1 and L2, to the inner side in the lateral direction of the road based on an offset amount ΔD2. For example, the offset amount ΔD2 may be set based on the relationship in FIG. 11 or FIG. 12. In FIG. 11 and FIG. 12, the offset amount ΔD2 is set to a value less than the offset amount ΔD1. As a result, the second offset boundary line LF2 is set as a boundary of which the offset amount relative to the boundary line L1 or L2 is less than that of the first offset boundary line LF1.

Then, at step S51, the ECU 10 performs the deviation suppression control based on the second offset boundary line LF2. At this time, the ECU 10 performs automatic steering by the steering apparatus 33 or issues a warning from the warning apparatus 34 as the deviation suppression process based on a result of a comparison of a lateral distance between the left or right end portion of the vehicle CA and the second offset boundary line LF2, to the distance threshold TH1.

As a result of the configuration according to the present embodiment, when the vehicle CA is traveling on a curved road, the deviation suppression process being unnecessarily performed can be suppressed, while collision with an obstacle ahead of the vehicle is suppressed.

### Third Embodiment

According to a third embodiment, the configuration is such that, when the offset boundary line LF is set on the inner side of either of the left and right boundary lines L1 and L2 of the travel lane LA, the offset boundary line LF is also set on the outer side of the other boundary line, and the deviation suppression control is performed based on the offset boundary lines LF on both the left and right sides.

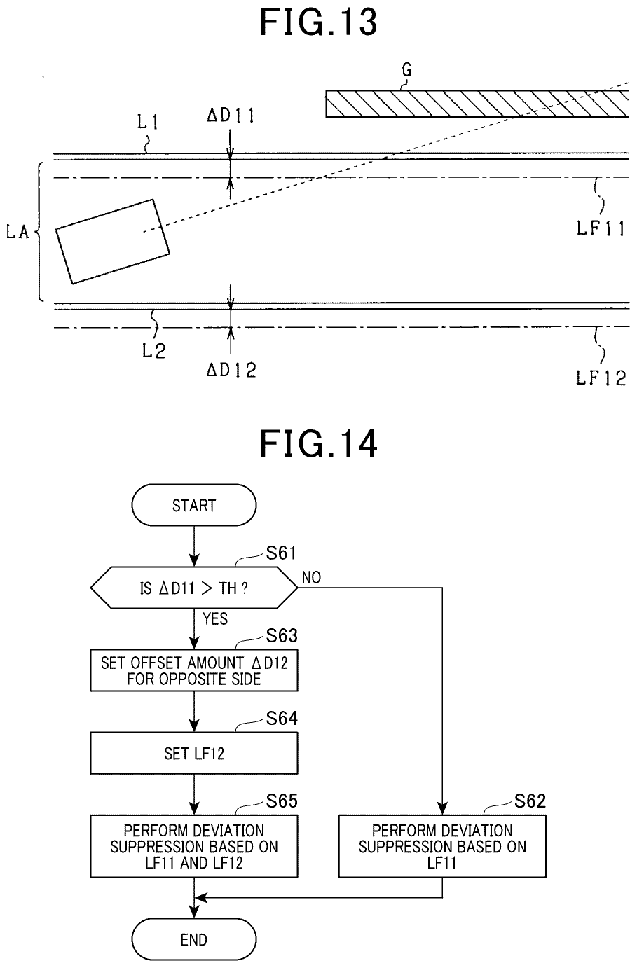

FIG. 13 is a plan view of a road showing a state in which the obstacle G is present on a side of the travel lane LA. In FIG. 13, the obstacle G is present on the outer side of the boundary line L1 on the left side, of the left and right boundary lines L1 and L2 of the travel lane LA. In addition, the travel path of the vehicle CA is in the obstacle overlapping state intersecting the boundary line L1 and overlapping the obstacle G on the far side of the boundary line L1. Furthermore, an inner offset boundary line LF11 is set on the inner side of the travel lane LA from the boundary line L1 that is a first reference boundary line. The inner offset boundary line LF11 is virtually drawn in a position on the inner side of the travel lane LA by an offset amount ΔD11 from the boundary line L1.

Here, when the inner offset boundary line LF11 is set inside the travel lane LA, a distance between the left and right reference boundary lines serving as reference for the deviation suppression control in the travel lane LA narrows, and the deviation suppression control is more easily performed. In this case, when the deviation suppression control is excessively performed, the driver may experience discomfort. For example, in the configuration in which the offset amount ΔD is variably set, the deviation suppression control may be excessively performed when the offset amount ΔD is equal to or greater than a predetermined amount or the travel lane LA has a narrow lane width.

Therefore, according to the present embodiment, when the inner offset boundary line LF11 is set on either of the left or right based on the travel path being in the obstacle overlapping state, an outer offset boundary line LF12 is set on the outer side of the boundary line on the other side. In FIG. 13, the outer offset boundary line LF12 is set on the side opposite the obstacle G, of the outer left and right sides of the travel lane LA. When the offset amount of the inner offset boundary line LF11 is ΔD11 and the offset amount of the outer offset boundary line LF12 is ΔD12, a relationship between ΔD11 and ΔD12 is ΔD1>ΔD12.

The ECU 10 performs a process shown in FIG. 14. For example, this process may be performed after step S20 in the flowchart in FIG. 6. In addition, in FIG. 6, at step S19, the ECU 10 sets the offset amount ΔD11 of the boundary line on the obstacle G side, of the boundary lines L1 and L2 on both left and right sides of the travel lane LA. At step S20, the ECU 10 sets the inner offset boundary line LF11 based on the offset amount ΔD11.

In FIG. 14, at step S61, the ECU 10 determines whether the offset amount ΔD11 of the inner offset boundary line LF11 is greater than a predetermined value TH. Here, the offset amount ΔD11 is variably set. That is, the offset amount ΔD11 is set based on the clearance D2 from the boundary line L1 or L2 to the obstacle G, the angle θ of the travelling direction of the vehicle CA to the boundary line L1 or L2, and the travel speed of the vehicle CA (see FIG. 4 and FIG. 5).

When determined that the offset amount ΔD11 is not greater than the predetermined value TH, the ECU 10 proceed to step S62. At step S62, the ECU 10 performs the deviation suppression control based on the inner offset border LF11. Here, on the side opposite the inner offset boundary line LF11, the deviation suppression control is performed based on the boundary line.

In addition, when determined that the offset amount ΔD11 is greater than the predetermined value TH, the ECU 10 proceed to step S63. At step S63, the ECU 10 sets the offset amount ΔD12 on the opposite side. At step S64, the ECU 10 sets the outer offset border LF12 based on the offset amount ΔD12 set at step S63. At step S65, the ECU 10 performs the deviation suppression control based on both left and right offset boundary lines LF11 and LF12.

At step S61, instead of or in addition to the process for determining whether the offset amount ΔD11 is greater than the predetermined value TH, a process for determining whether the lane width is less than a predetermined value may be performed. In this case, the outer offset boundary line LF12 is set under a condition that the lane width is less than the predetermined value. Here, the processes at steps S61 and S62 can also be omitted.

As a result of the configuration according to the present embodiment, the deviation suppression control can be appropriately performed while the deviation suppression control being excessively performed is suppressed.

### Other Embodiments

For example, the above-described embodiments may be modified in the following manner.

According to the above-described embodiments, the configuration is such that the travel path of the vehicle CA is set as the path area EA having the vehicle width. However, this may be modified. The travel path of the vehicle CA need not have the vehicle width. For example, the configuration may be such that the travel path is set at the center position in the width direction of the vehicle CA.

A vehicle speed condition may be prescribed as the condition for performing the deviation suppression control. The deviation suppression control may be performed under a condition that the travel speed of the vehicle is equal to or greater than a predetermined speed (such as 30 km/h).

The control apparatus and a method thereof described in the present disclosure may be implemented by a dedicated computer that is provided such as to be configured by a processor and a memory, the processor being programmed to provide one or more functions that are implemented by a computer program. Alternatively, the control apparatus and a method thereof described in the present disclosure may be ac implemented by a dedicated computer that is provided by a processor being configured by one or more dedicated hardware logic circuits. As another alternative, the control unit and a method thereof described in the present disclosure may be implemented by one or more dedicated computers. The dedicated computer may be configured by a combination of a processor that is programmed to provide one or more functions, a memory, and a processor that is configured by one or more hardware logic circuits. In addition, the computer program may be stored in a non-transitory, tangible storage medium that can be read by a computer as instructions performed by the computer.

Technical ideas extracted from the above-described embodiments are described below.

### First Configuration

A vehicle control apparatus (10) configured to perform deviation suppression control to prevent a vehicle from deviating outside left and right reference boundary lines when traveling on a road, the reference boundary line being either of road boundary lines that are left and right road edges of the road, and left and right boundary lines of a travel lane in the road, the vehicle control apparatus including: at least one of (i) a circuit and (ii) a processor with a memory storing computer program code executable by the processor, the at least one of the circuit and the processor configured to implement: a travel path setting unit (11) that sets a travel path ahead of the vehicle in a travelling direction; an obstacle recognition unit (13) that recognizes presence of an obstacle ahead of the vehicle; an overlap determination unit (14) that, in response to an object being recognized as being present ahead of the vehicle, determines whether the travel path is in an obstacle overlapping state intersecting the reference boundary line and overlapping the obstacle on a far side of the reference boundary line; and a control unit (15) that, in response to the travel path being determined to be in the obstacle overlapping state, sets an offset boundary line by offsetting the reference boundary line to an inner side in a lateral direction of the road and performs the deviation suppression control based on the offset boundary line.

### Second Configuration

The vehicle control apparatus according to the first configuration, in which: the control unit has a boundary positioning unit (16) that determines a position of the offset boundary line based on a clearance in the lateral direction of the road between the reference boundary line and the obstacle, in response to the travel path being determined to be in the obstacle overlapping state.

### Third Configuration

The vehicle control apparatus according to the first configuration, in which: the control unit has a boundary positioning unit (16) that determines a position of the offset boundary line based on at least either of an angle at which the travelling direction of the vehicle intersects the reference boundary line and a travel speed of the vehicle, in response to the travel path being determined to be in the obstacle overlapping state.

### Fourth Configuration

The vehicle control apparatus according to the first configuration, in which: the control unit sets the offset boundary line to be extended ahead of the vehicle in the travelling direction in a predetermined section even after the vehicle passes a side of the obstacle, in response to the travel path being determined to be in the obstacle overlapping state.

### Fifth Configuration

The vehicle control apparatus according to any one of the first to fourth configurations, further including: a scene determination unit that determines whether a travel scene is a first travel scene in which a straight road is ahead of the vehicle in the travelling direction and the straight road is in the obstacle overlapping state, and determines whether the travel scene is a second travel scene in which a curved road is ahead of the vehicle in the travelling direction and the curved road is in the obstacle overlapping state, in which the control unit sets a first offset boundary line as the offset boundary line in response to the travel scene being determined to be the first travel scene, sets a second offset boundary line as the offset boundary line in response to the travel scene being determined to be the second travel scene, and the second offset boundary line has an offset amount relative to the reference boundary line that is less than that of the first offset boundary line.

### Sixth Configuration

The vehicle control apparatus according to any one of the first to fifth configurations, in which: in response to an inner offset boundary line being set as the offset boundary line based on the travel path being in the obstacle overlapping state on the inner side of a first reference boundary line in the lateral direction of the road, of the first reference boundary line and a second reference boundary line that are left and right reference boundary lines, the control unit sets an outer offset boundary line having an offset amount that is less than that of the inner offset boundary line on an outer side of the second reference boundary line in the lateral direction of the road, and performs the deviation suppression control based on the inner offset boundary line and the outer offset boundary line.

### Seventh Configuration

The vehicle control apparatus according to the sixth configuration 6, in which: the control unit sets the offset amount relative to the first reference boundary line to be variable in response to the inner offset boundary line being set, and sets the outer offset boundary line in addition to the inner offset boundary line under a condition that the offset amount of the inner offset boundary line is equal to or greater than a predetermined amount.

### Eighth Configuration

A non-transitory computer-readable storage medium storing therein a program for performing deviation suppression control to prevent a vehicle from deviating outside left and right reference boundary lines when traveling on a road, the reference boundary line being either of road boundary lines that are left and right road edges of the road, and left and right boundary lines of a travel lane in the road, the program causing a processor to perform: a travel path setting process for setting a travel path ahead of the vehicle in a travelling direction; an obstacle recognition process for recognizing presence of an obstacle ahead of the vehicle; an overlap determination process for, in response to an object being recognized as being present ahead of the vehicle, determining whether the travel path is in an obstacle overlapping state intersecting the reference boundary line and overlapping the obstacle on a far side of the reference boundary line; and a control process for, in response to the travel path being determined to be in the obstacle overlapping state, setting an offset boundary line by offsetting the reference boundary line to an inner side in a lateral direction of the road and performing the deviation suppression control based on the offset boundary line.

### Ninth Configuration

A vehicle control method for performing deviation suppression control to prevent a vehicle from deviating outside left and right reference boundary lines when traveling on a road, the reference boundary line being either of road boundary lines that are left and right road edges of the road, and left and right boundary lines of a travel lane in the road, the vehicle control method including: setting a travel path ahead of the vehicle in a travelling direction; recognizing presence of an obstacle ahead of the vehicle; in response to an object being recognized as being present ahead of the vehicle, determining whether the travel path is in an obstacle overlapping state intersecting the reference boundary line and overlapping the obstacle on a far side of the reference boundary line; and in response to the travel path being determined to be in the obstacle overlapping state, setting an offset boundary line by offsetting the reference boundary line to an inner side in a lateral direction of the road and performs the deviation suppression control based on the offset boundary line.

What is claimed is:

1. A vehicle control apparatus configured to perform deviation suppression control to prevent a vehicle from deviating outside left and right reference boundary lines when traveling on a road, the reference boundary line being either of road boundary lines that are left and right road edges of the road, and left and right boundary lines of a travel lane in the road, the vehicle control apparatus comprising:
at least one of (i) a circuit and (ii) a processor with a memory storing computer program code executable by the processor, the at least one of the circuit and the processor configured to implement:
a travel path setting unit that sets a travel path ahead of the vehicle in a travelling direction;
an obstacle recognition unit that recognizes presence of an obstacle ahead of the vehicle;
an overlap determination unit that, in response to an object being recognized as being present ahead of the vehicle, determines whether the travel path is in an obstacle overlapping state intersecting the reference boundary line and overlapping the obstacle on a far side of the reference boundary line; and
a control unit that, in response to the travel path being determined to be in the obstacle overlapping state, sets an offset boundary line by offsetting the reference boundary line to an inner side in a lateral direction of the road and performs the deviation suppression control based on the offset boundary line.

2. The vehicle control apparatus according to claim 1, wherein:
the control unit has a boundary positioning unit that determines a position of the offset boundary line based on a clearance in the lateral direction of the road between the reference boundary line and the obstacle, in response to the travel path being determined to be in the obstacle overlapping state.

3. The vehicle control apparatus according to claim 1, wherein:
the control unit has a boundary positioning unit that determines a position of the offset boundary line based on at least either of an angle at which the travelling direction of the vehicle intersects the reference boundary line and a travel speed of the vehicle, in response to the travel path being determined to be in the obstacle overlapping state.

4. The vehicle control apparatus according to claim 1, wherein:
the control unit sets the offset boundary line to be extended ahead of the vehicle in the travelling direction in a predetermined section even after the vehicle passes a side of the obstacle, in response to the travel path being determined to be in the obstacle overlapping state.

5. The vehicle control apparatus according to claim 1, further comprising:
a scene determination unit that
determines whether a travel scene is a first travel scene in which a straight road is ahead of the vehicle in the travelling direction and the straight road is in the obstacle overlapping state, and
determines whether the travel scene is a second travel scene in which a curved road is ahead of the vehicle in the travelling direction and the curved road is in the obstacle overlapping state, wherein
the control unit
sets a first offset boundary line as the offset boundary line in response to the travel scene being determined to be the first travel scene,
sets a second offset boundary line as the offset boundary line in response to the travel scene being determined to be the second travel scene, and
the second offset boundary line has an offset amount relative to the reference boundary line that is less than that of the first offset boundary line.

6. The vehicle control apparatus according to claim 2, further comprising:
a scene determination unit that
determines whether a travel scene is a first travel scene in which a straight road is ahead of the vehicle in the travelling direction and the straight road is in the obstacle overlapping state, and
determines whether the travel scene is a second travel scene in which a curved road is ahead of the vehicle in the travelling direction and the curved road is in the obstacle overlapping state, wherein
the control unit
sets a first offset boundary line as the offset boundary line in response to the travel scene being determined to be the first travel scene,
sets a second offset boundary line as the offset boundary line in response to the travel scene being determined to be the second travel scene, and
the second offset boundary line has an offset amount relative to the reference boundary line that is less than that of the first offset boundary line.

7. The vehicle control apparatus according to claim 3, further comprising:
a scene determination unit that
determines whether a travel scene is a first travel scene in which a straight road is ahead of the vehicle in the travelling direction and the straight road is in the obstacle overlapping state, and
determines whether the travel scene is a second travel scene in which a curved road is ahead of the vehicle in the travelling direction and the curved road is in the obstacle overlapping state, wherein
the control unit
sets a first offset boundary line as the offset boundary line in response to the travel scene being determined to be the first travel scene,
sets a second offset boundary line as the offset boundary line in response to the travel scene being determined to be the second travel scene, and
the second offset boundary line has an offset amount relative to the reference boundary line that is less than that of the first offset boundary line.

8. The vehicle control apparatus according to claim 4, further comprising:
a scene determination unit that
determines whether a travel scene is a first travel scene in which a straight road is ahead of the vehicle in the travelling direction and the straight road is in the obstacle overlapping state, and
determines whether the travel scene is a second travel scene in which a curved road is ahead of the vehicle in the travelling direction and the curved road is in the obstacle overlapping state, wherein
the control unit
sets a first offset boundary line as the offset boundary line in response to the travel scene being determined to be the first travel scene,
sets a second offset boundary line as the offset boundary line in response to the travel scene being determined to be the second travel scene, and
the second offset boundary line has an offset amount relative to the reference boundary line that is less than that of the first offset boundary line.

9. The vehicle control apparatus according to claim 1, wherein:
the control unit
in response to an inner offset boundary line being set as the offset boundary line based on the travel path being in the obstacle overlapping state on the inner side of a first reference boundary line in the lateral direction of the road, of the first reference boundary line and a second reference boundary line that are left and right reference boundary lines, sets an outer offset boundary line having an offset amount that is less than that of the inner offset boundary line on an outer side of the second reference boundary line in the lateral direction of the road, and
performs the deviation suppression control based on the inner offset boundary line and the outer offset boundary line.

10. The vehicle control apparatus according to claim 2, wherein:
the control unit
in response to an inner offset boundary line being set as the offset boundary line based on the travel path being in the obstacle overlapping state on the inner side of a first reference boundary line in the lateral direction of the road, of the first reference boundary line and a second reference boundary line that are left and right reference boundary lines, sets an outer offset boundary line having an offset amount that is less than that of the inner offset boundary line on an outer side of the second reference boundary line in the lateral direction of the road, and
performs the deviation suppression control based on the inner offset boundary line and the outer offset boundary line.

11. The vehicle control apparatus according to claim 3, wherein:
the control unit
in response to an inner offset boundary line being set as the offset boundary line based on the travel path being in the obstacle overlapping state on the inner side of a first reference boundary line in the lateral direction of the road, of the first reference boundary line and a second reference boundary line that are left and right reference boundary lines, sets an outer offset boundary line having an offset amount that is less than that of the inner offset boundary line on an outer side of the second reference boundary line in the lateral direction of the road, and
performs the deviation suppression control based on the inner offset boundary line and the outer offset boundary line.

12. The vehicle control apparatus according to claim 4, wherein:
the control unit
in response to an inner offset boundary line being set as the offset boundary line based on the travel path being in the obstacle overlapping state on the inner side of a first reference boundary line in the lateral direction of the road, of the first reference boundary line and a second reference boundary line that are left and right reference boundary lines, sets an outer offset boundary line having an offset amount that is less than that of the inner offset boundary line on an outer side of the second reference boundary line in the lateral direction of the road, and
performs the deviation suppression control based on the inner offset boundary line and the outer offset boundary line.

13. The vehicle control apparatus according to claim 9, wherein:
the control unit
sets the offset amount relative to the first reference boundary line to be variable in response to the inner offset boundary line being set, and
sets the outer offset boundary line in addition to the inner offset boundary line under a condition that the offset amount of the inner offset boundary line is equal to or greater than a predetermined amount.

14. The vehicle control apparatus according to claim 10, wherein:
the control unit
sets the offset amount relative to the first reference boundary line to be variable in response to the inner offset boundary line being set, and
sets the outer offset boundary line in addition to the inner offset boundary line under a condition that the offset amount of the inner offset boundary line is equal to or greater than a predetermined amount.

15. The vehicle control apparatus according to claim 11, wherein:
the control unit
sets the offset amount relative to the first reference boundary line to be variable in response to the inner offset boundary line being set, and
sets the outer offset boundary line in addition to the inner offset boundary line under a condition that the offset amount of the inner offset boundary line is equal to or greater than a predetermined amount.

16. The vehicle control apparatus according to claim 12, wherein:
the control unit
sets the offset amount relative to the first reference boundary line to be variable in response to the inner offset boundary line being set, and
sets the outer offset boundary line in addition to the inner offset boundary line under a condition that the offset amount of the inner offset boundary line is equal to or greater than a predetermined amount.

17. A non-transitory computer-readable storage medium storing therein a program for performing deviation suppression control to prevent a vehicle from deviating outside left and right reference boundary lines when traveling on a road, the reference boundary line being either of road boundary lines that are left and right road edges of the road, and left and right boundary lines of a travel lane in the road, the program causing a processor to perform:
a travel path setting process for setting a travel path ahead of the vehicle in a travelling direction;
an obstacle recognition process for recognizing presence of an obstacle ahead of the vehicle;
an overlap determination process for, in response to an object being recognized as being present ahead of the vehicle, determining whether the travel path is in an obstacle overlapping state intersecting the reference boundary line and overlapping the obstacle on a far side of the reference boundary line; and
a control process for, in response to the travel path being determined to be in the obstacle overlapping state, setting an offset boundary line by offsetting the reference boundary line to an inner side in a lateral direction of the road and performing the deviation suppression control based on the offset boundary line.

18. A vehicle control method for performing deviation suppression control to prevent a vehicle from deviating outside left and right reference boundary lines when traveling on a road, the reference boundary line being either of road boundary lines that are left and right road edges of the road, and left and right boundary lines of a travel lane in the road, the vehicle control method comprising:
setting a travel path ahead of the vehicle in a travelling direction;
recognizing presence of an obstacle ahead of the vehicle;
in response to an object being recognized as being present ahead of the vehicle, determining whether the travel path is in an obstacle overlapping state intersecting the reference boundary line and overlapping the obstacle on a far side of the reference boundary line; and
in response to the travel path being determined to be in the obstacle overlapping state, setting an offset boundary line by offsetting the reference boundary line to an inner side in a lateral direction of the road and performs the deviation suppression control based on the offset boundary line.
